(19) United States
(12) Patent Application Publication
(10) Pub. No.: US 2021/0403357 A1
(43) Pub. Date: Dec. 30, 2021

(54) ELECTROCHEMICAL WASTEWATER TREATMENT SYSTEM WITH CONTROL OF SELECTED COMPOUNDS CONCENTRATION IN THE REACTOR

(71) Applicant: Axine Water Technologies Inc., Vancouver (CA)

(72) Inventor: Geoffrey Sean Milburn, Ottawa (CA)

(21) Appl. No.: 17/287,948

(22) PCT Filed: Oct. 24, 2019
(86) PCT No.: PCT/US2019/057851

§ 371 Date: Apr. 22, 2021

Related U.S. Application Data
(60) Provisional application No. 62/750,354, filed on Oct. 25, 2018.

(51) Int. Cl. C02F 9/00; B01D 61/12; B01D 61/02; B01D 61/08; B01D 61/04; B01D 61/14; B01D 61/16; B01D 61/18; B01D 61/22; B01D 65/02

(52) U.S. Cl. CPC C02F 9/00; B01D 61/12; B01D 61/025; B01D 61/027; B01D 61/08; C02F 1/4672; B01D 61/145; B01D 61/16; B01D 61/18; B01D 61/22; B01D 65/02; B01D 61/04

(57) ABSTRACT

An electrochemical wastewater treatment system comprises a reactor tank, an electrochemical reactor and a separation device which filters the effluent stream from the reactor tank and generates a treated wastewater stream and a reject stream which is at least partially fed to the electrochemical reactor or to the reactor tank to thereby increase the concentration of selected soluble and insoluble compounds within the reactor. A portion of the reject stream or a portion of the wastewater in the reactor tank can be discharged as a blowdown stream. Flow control means are provided for adjusting the volume of the reject stream and of the blowdown stream for controlling the compounds concentration. The concentration of soluble and insoluble compounds in the reactor is therefore decoupled from the concentration of the compounds in the reactor effluent stream to achieve an improved reactor performance and a higher quality effluent.

### TECHNICAL FIELD

The present invention relates to an electrochemical wastewater treatment system in which the concentration of soluble and insoluble compounds within the reactor is decoupled from the concentration of soluble and insoluble compounds in the effluent exiting the reactor to achieve an improved reactor performance and a higher quality effluent.

### BACKGROUND

Wastewater treatment systems are high in demand due to tighter wastewater disposal regulations, whereby industrial facilities are required to eliminate their recalcitrant water pollutants prior to discharge, and due to the current global shortage of clean water. Therefore, there is an increasing demand of cost-effective, sustainable wastewater treatment systems that minimize the addition of chemicals, do not produce secondary pollution, and have minimal operational and maintenance requirements.

The preferred approach to treat recalcitrant wastewater is by electrochemical oxidation, which is a sustainable, safe and highly efficient treatment solution for eliminating a wide variety of pollutants such as persistent organic pollutants, dioxins, nitrogen species (e.g. ammonia), pharmaceuticals pathogens, microorganisms and others. One approach for treating wastewater is by direct electrochemical oxidation of organic and/or inorganic pollutants whereby such pollutants are oxidized directly on the anode surface. Another method is the indirect electrochemical oxidation of organic and/or inorganic pollutants through the in-situ generation of chemically oxidizing species (such as hydroxyl, chlorine, oxygen or perchlorate radicals or compounds such as hypochlorite, ozone, or hydrogen peroxide). These chemically oxidizing species are generated directly on the anode surface and subsequently oxidize pollutants within the wastewater solution.

In wastewater treatment systems employing electrochemical oxidation, the wastewater is generally fed to a reactor tank and then transferred by a pump to the reactor where it is treated for pollutant removal. If the reactor is a flow-through reactor or a constantly stirred tank reactor (CSTR) the contaminant concentrations of the effluent are generally the same as the contaminant concentrations within the reactor. This is not preferred because higher contaminant concentrations within the reactor generally lead to higher treatment efficiencies, while it is desired for the effluent to have lower contaminant concentrations. It is also desirable for certain compounds in the reactor tank to pass quickly through the reactor and stay in low concentrations (e.g. hardness components) and for other compounds to be retained in the reactor so that a higher concentration of these compounds is gradually build up within the reactor (e.g. electrolyte). Additionally, it may be desired to only treat certain compounds (i.e. higher molecular weight compounds such as APIs (Active Pharmaceutical Ingredients)) and allow other compounds in the wastewater to pass through.

Batch reactors have also been used in the past instead of constantly stirred tank reactors to treat wastewater at higher efficiencies. Batch reactors can treat wastewater to a low contaminant level, but require increased time to achieve this low contaminant level and consume more energy as a result.

Therefore, there is a need to further improve the system design and the method of operating the system employing electrochemical oxidation for treating wastewater to achieve a more efficient operation of existing reactors.

### SUMMARY OF THE INVENTION

The present invention describes an electrochemical wastewater treatment system comprising:
a reactor tank which receives a stream of wastewater to be treated;
an electrochemical reactor; and
a separation device which receives an effluent wastewater stream from the reactor tank to generate a treated wastewater stream which is discharged from the system and a reject stream which is at least partially supplied to the electrochemical reactor or back to the reactor tank as a recirculated wastewater stream.

In some embodiments the recirculated wastewater stream is supplied directly to the electrochemical reactor and in other embodiments, the recirculated wastewater stream is supplied to the reactor tank where it mixes with the wastewater from the reactor tank and the mixed wastewater is supplied to the electrochemical reactor. The electrochemical reactor treats the recirculated wastewater stream supplied from the separation device or, alternatively, the recirculated wastewater mixed with the wastewater in the reactor tank, and generates a reactor effluent stream which is fed back to the reactor tank.

The system can further comprise control means for adjusting the volume of the reject stream and of the recirculated wastewater stream for controlling the concentration of compounds in the electrochemical reactor.

In some embodiments, a portion of the reject stream can be discharged from the system as a blowdown stream and in such embodiments the wastewater treatment system comprises control means for adjusting the volume of the blowdown stream.

In other embodiments a portion of the wastewater contained in the reactor tank is discharged from the system as a blowdown stream and the system further comprises control means for adjusting the volume of the blowdown stream.

In some embodiments, the blowdown stream and the treated wastewater stream are combined into a treated water stream before being discharged from the system.

The control means for adjusting the volume of the reject stream and/or of the recirculated wastewater stream can comprise a pump for feeding the effluent wastewater stream from the reactor tank to the separation device and/or valve which regulates the flow of the reject stream and/or at least a valve which regulates the flow of the recirculated wastewater stream.

The control means for adjusting the volume of the blowdown stream generally comprise at least one valve for regulating the flow of the blowdown stream.

The separation device in the present wastewater treatment system can comprise a reverse osmosis membrane, a nanofiltration membrane, an ultrafiltration membrane, or another type of membrane that separates compounds via molecular size, charge, or by other characteristics, or it can be a distillation device or a concentration device or a combination of the above. The type and the characteristics of the separation device are generally selected for controlling the concentration of the compounds in the reject stream and in the electrochemical reactor, for either soluble, or insoluble compounds or for both.

The wastewater treatment system further comprises a device for storing and delivering to the reactor tank a solution for increasing the wastewater conductivity, a solution for controlling the pH of the wastewater and/or a membrane solutions such as descalants, dechlorination agents, or biocides.

In some embodiments, the wastewater treatment system further comprises a conditioning tank which receives a predetermined amount of the stream of wastewater to be treated before it is supplied to the reactor tank, mixes it with the recirculated wastewater stream from the separation device and treats it to remove specific compounds and a pump for further supplying the wastewater to be treated from the conditioning tank to the reactor tank.

In some embodiments, for example for systems operating in batch mode, a membrane feed tank is provided for receiving the effluent wastewater stream from the reactor tank and a pump supplies the wastewater from the membrane feed tank further to the separation device.

A method for wastewater treatment in an electrochemical reactor is further disclosed comprising the steps of:
a. supplying the wastewater to be treated to a reactor tank and discharging an effluent wastewater stream from the reactor tank;
b. supplying the effluent wastewater stream from the reactor tank to a separation device where the effluent wastewater stream is concentrated to generate a treated wastewater stream and a reject stream containing the compounds which were rejected by the separation device;
c. supplying at least a portion of the reject stream to an electrochemical reactor or to the reactor tank as a recirculated wastewater stream;
d. electrochemically treating the recirculated wastewater stream or the wastewater supplied from the reactor tank, which contains the recirculated wastewater stream, in the electrochemical reactor and generating a reactor effluent stream of electrochemically treated water;
e. supplying the reactor effluent stream from the electrochemical reactor back to the reactor tank;
f. controlling the volume of the reject stream and of the recirculated wastewater stream supplied either to the electrochemical reactor or to the reactor tank for controlling the concentration of the compounds in the electrochemical reactor, and
g. discharging the treated wastewater stream from system.

As seen in the steps above, in some embodiments the reject stream is supplied as recirculated wastewater directly to the electrochemical reactor while in other embodiments the reject stream is first supplied as recirculated wastewater to the reactor tank, where it mixes with the wastewater to be treated, and then the mix is supplied from the reactor tank to the electrochemical reactor.

In some embodiments, the method further comprises discharging a portion of the reject stream as a blowdown stream to further control the compounds concentration in the electrochemical reactor.

In other embodiments, the method further comprises discharging a portion of the wastewater contained in the reactor tank as a blowdown stream to further control the compounds concentration in the electrochemical reactor.

In some embodiments the blowdown stream is combined with the treated wastewater stream before being discharged from the system as a treated water stream.

In a preferred embodiment, the method for wastewater treatment comprises the steps of:
a. supplying a predetermined volume of wastewater to be treated to a conditioning tank to remove some of the contaminants and from the conditioning tank to a reactor tank and discharging an effluent wastewater stream from the reactor tank;
b. supplying the effluent wastewater stream from the reactor tank to a membrane feed tank and from the membrane feed tank to a separation device where the effluent wastewater stream is concentrated to generate a treated wastewater stream and a reject stream which contains the compounds which were rejected by the separation device;
c. supplying the entire reject stream to the conditioning tank where it is mixed with the wastewater to be treated and it is then supplied to the reactor tank;
d. supplying the wastewater from the reactor tank which comprises the reject stream to an electrochemical reactor;
e. electrochemically treating the wastewater supplied from the reactor tank in the electrochemical reactor and generating a reactor effluent stream;
f. supplying the reactor effluent stream from the electrochemical reactor back to the reactor tank;
g. discharging the treated wastewater stream from the system; and
h. supplying a new volume of wastewater to be treated to the conditioning tank and repeating the above steps for the next batch of wastewater to be treated.

In this embodiment, the system is operated in a batch mode with the wastewater to be treated being supplied in batches to the system and not in a continuous flow as in the other embodiments.

In all embodiments where the separation device comprises a membrane, the membrane is selected for controlling the concentration of the compounds and implicitly of the contaminants in the reject stream.

In all embodiments the method can further comprise storing and delivering to the reactor tank a solution for increasing the wastewater conductivity, a solution for controlling the pH of the wastewater, a membrane descaling solution, or other solutions to optimize contaminant removal or system performance.

### BRIEF DESCRIPTION OF THE DRAWINGS

The drawings illustrate specific preferred embodiments of the invention, but should not be considered as restricting the spirit or scope of the invention in any way.

FIG. 1 illustrates a first embodiment of the present invention.

FIG. 2 illustrates a second embodiment of the present invention.

FIG. 3 illustrated a third embodiment of the present invention.

FIGS. 4a and 4b illustrate the contaminant concentrations achieved with a reactor according to an embodiment of the present invention and respectively with a constantly stirred tank reactor with 1, 2 or 3 stages, known in the prior art.

FIG. 5 illustrates a fourth embodiment of the present invention for a system operating in batch mode.

### DETAILED DESCRIPTION

Certain terminology is used in the present description and is intended to be interpreted according to the definitions provided below. In addition, terms such as “a” and “comprises” are to be taken as open-ended.

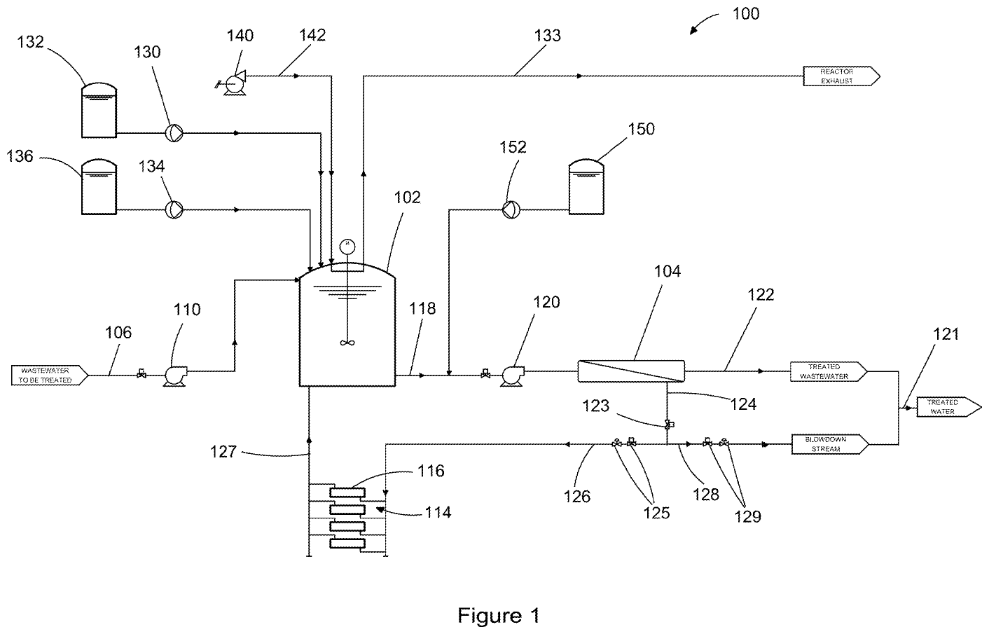

An electrochemical wastewater treatment system according to the first embodiment of the present invention is illustrated in FIG. 1.

The electrochemical wastewater treatment system 100 comprises a reactor tank 102 and a separation device 104, located downstream of the reactor tank 102. The stream of wastewater that needs to be treated 106 is fed by a pump 110 to the reactor tank 102 and the effluent wastewater stream 118 from the reactor tank is fed by a pump 120 to the separation device 104. The effluent wastewater stream 118 is treated in the separation device 104 by separating selected soluble and insoluble compounds and the wastewater that is rejected from the separation device forms a reject stream 124. At least a portion of the reject stream 124 forms a recirculated wastewater stream 126 and is directed to the electrochemical reactor 114 where it is electrochemically treated and the electrochemically treated wastewater exits the reactor forming a reactor effluent stream 127. The electrochemical reactor can comprise several electrochemical cells 116 which can use various catalysts for treating the contaminants in the wastewater. The reactor effluent stream 127 is fed back to the reactor tank 102 where it is combined with the incoming stream of wastewater that needs to be treated 106 and the process is repeated. The treated wastewater stream 122 which has passed through the membrane flows out of the separation device 104.

In some embodiments the entire reject stream is returned to the reactor as a recirculated wastewater stream. In other embodiments, such as the one illustrated in FIG. 1, the reject stream 124 is divided into a recirculated wastewater stream 126 which is fed to the electrochemical reactor 114 and a blowdown stream 128 which can be discharged to storage or blended with the treated wastewater stream 122 to form a treated water stream 121, as illustrated in FIG. 1. The treated water stream can be discharged into a tank for reuse or storage, or can be discharged to a sewer or a surface water body. The recirculated wastewater stream 126 is generally larger in volume than the blowdown stream 128. By feeding at least a portion of the reject stream 124 to the electrochemical reactor 114 as a recirculated wastewater stream the contaminant concentration within the electrochemical reactor is higher than it would be if the effluent wastewater stream 118 would be directly fed from the reactor tank to the electrochemical reactor and it is higher than the contaminant concentration in the reactor effluent stream 127. Furthermore, since the compounds that are fed to the electrochemical reactor 114 are selected according to the type of membrane or of the separation process used in the separation device 104, the type and quantity of the compounds and implicitly of the wastewater contaminants directed to the electrochemical reactor 114 can be easily controlled.

The present system and method are beneficial for the efficiency of the wastewater treatment operation since it is desirable to have higher contaminant concentrations within the electrochemical reactor to increase the system's operating efficiency and it is also beneficial to recirculate back to the reactor certain compounds which have been added to the wastewater, such as electrolyte, solution control compounds and pH control substances. The contaminant concentration in the electrochemical reactor 114 is controlled by controlling the volume of the recirculated wastewater stream 126 which is fed into the electrochemical reactor 114 and by controlling the volume of the blowdown stream 128 in the embodiments which allow such a method. The flow of the recirculated wastewater stream 126 is controlled by valve 123 and valves 125 and the flow of the blowdown stream 128 is controlled by valve 123 and valves 129.

The type of membrane or the process to be used in the separation device 104 can be chosen according to the compounds/contaminants that need to be filtered and/or to the compounds/contaminants that should be allowed to pass through. Generally a reverse osmosis membrane is used for retaining most soluble compounds including monovalent and divalent compounds, which will be retained in the reject stream and will be recirculated to the reactor (e.g. chloride which is recycled back to the reactor tank for ammonia treatment, sodium sulfate which is recycled back to the reactor tank for improving conductivity, etc.). Alternatively a nano-filtration or an ultrafiltration membrane can be used in the separation device 104, and such membrane will reject the passage of larger contaminants such as pharmaceutical active ingredients which will be recycled back to the electrochemical reactor for treatment. Other membrane types that separate compounds via molecular size, charge, or other characteristics, or via a combination of the above can be used in the separation device 104. Membranes made of various materials (polyvinylidene fluoride, polysulfone, polyacrylonitrile, cellulose acetate-cellulose nitrate blends, polytetrafluorethylene, ceramics, etc) may be utilized for treatment. Also the separation device can use distillation or a similar process for separating contaminants, instead of using a membrane. In any case, the membrane or the separation process used in the separation device has high rejection of any soluble or insoluble contaminants that need to be removed from the wastewater stream.

In the illustrated embodiment an electrolyte solution for increasing the conductivity of the wastewater, for example sodium sulfate (Na₂SO₄) is supplied by a pump 130 from a tank 132 to the reactor tank 102 and a pH control solution, for example sodium hydroxide (NaOH) is supplied by a pump 134 from a tank 136 to the reactor tank 102.

The electrochemical wastewater treatment system 100 can further comprise an air fan pump 140 which pumps a stream of fresh air 142 to the top of the reactor tank 102 to entrain the exhaust gases which are generated within the reactor tank and to eliminate them to the outside as reactor exhaust 133.

For the embodiments which use a membrane in the separation device, the electrochemical wastewater treatment system can also comprise a membrane pretreatment solution tank 150 from which a pretreatment solution such as antiscalant, biocide or sodium metabisulfite (SMBS) is fed through the pump 152 to the effluent wastewater stream and is carried over to the separation device 104 for maintaining the condition of the membrane at an optimum level.

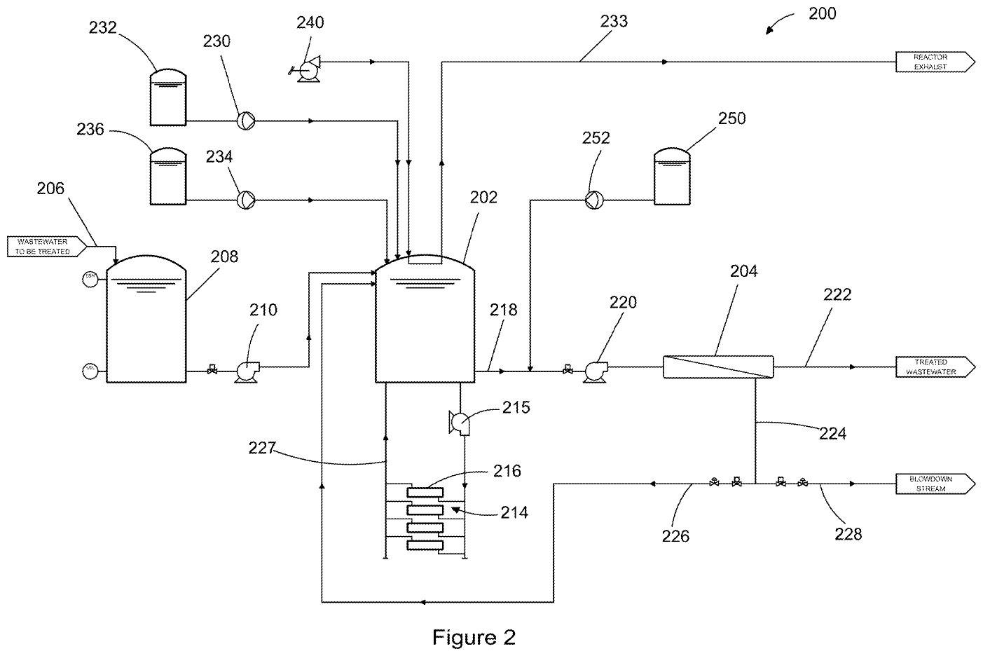

Another embodiment of the present invention is illustrated in FIG. 2. The electrochemical wastewater treatment system 200 comprises a reactor tank 202, an electrochemical reactor 214 and a separation device 204. In this embodiment, the stream of wastewater to be treated 206 is first fed into an equalization tank 208 and then through a pump 210 to the reactor tank 202. From the reactor tank 202 the wastewater is fed by a pump 215 to the electrochemical reactor 214 where it is electrochemically treated. The electrochemical reactor 214 can comprise several electrochemical cells 216 which can use various catalysts for treating the contaminants in the wastewater. The reactor effluent stream 227 is fed back to the reactor tank 202.

The effluent wastewater stream 218 is fed by a pump 220 from the reactor tank 202 to the separation device 204, where selected soluble and insoluble compounds are filtered from the effluent wastewater stream 218 and create the reject stream 224 and the treated wastewater stream 222 flows out of the separation device 204 and can be discharged to a tank for reuse or storage, or discharged to a sewer or to a surface water body.

The reject stream 224 which is separated from the effluent wastewater stream 218 flows out of the separation device 204 and is divided into two streams, a first stream, which is the recirculated wastewater stream 226 which flows back to the reactor tank 202 and a second stream, the blowdown stream 228 which is discharged from the system. The recirculated wastewater stream 226 is generally larger in volume than the blowdown stream 228. By returning a portion of the reject stream 224 back into the reactor tank 202 as a recirculated wastewater stream 226, the concentration of the contaminant in the wastewater within the reactor tank 202 which is further supplied to the electrochemical reactor 214 is increased. Furthermore since the compounds that are returned to the reactor tank 202 are selected according to the type of membrane or of the type of process used in the separation device 204, the type and quantity of the compounds returned to the reactor tank 202 and which are returned to the electrochemical reactor 214 can be easily controlled.

The electrochemical wastewater treatment system 200 can further comprise an air fan pump 240 which pumps a stream of fresh air to the top of the reactor tank 202 to exhaust the gases generated during the wastewater treatment as reactor exhaust 233.

If the separation device 204 comprises a separation membrane, the electrochemical wastewater treatment system can also comprise a membrane pretreatment solution tank 250 from which a pretreatment solution (antiscalant, biocide, SMBS) is fed through the pump 252 to the effluent wastewater stream 218 and is carried over to the separation device 204 for maintaining the condition of the membrane at an optimum level.

As in the first embodiment, a solution for increasing the conductivity of the wastewater, for example sodium sulfate (Na₂SO₄) is supplied by a pump 230 from a tank 232 to the reactor tank 202 and a pH control solution, for example sodium hydroxide (NaOH) is supplied by a pump 234 from a tank 236.

This second embodiment of the present invention has the same advantages as the first embodiment described above. The concentration of the soluble and insoluble compounds (including contaminants) in the reactor tank 202 and in the electrochemical reactor 214 is increased and can be controlled by controlling the amount of pass-through which is recirculated back to the reactor tank 202 as recirculated wastewater stream 226 and by controlling the portion of the reject stream 224 which is discharged as blowdown stream 228 in the systems which offer this option. The membrane used in the separation device 204 can be a reverse osmosis membrane, a nano-filtration membrane, an ultrafiltration membrane or any other type of membrane which separates compounds via molecular size, charge, other characteristics, or via a combination of the above or it can be a separation device using distillation or another process known in the art for separating the insoluble or soluble contaminants.

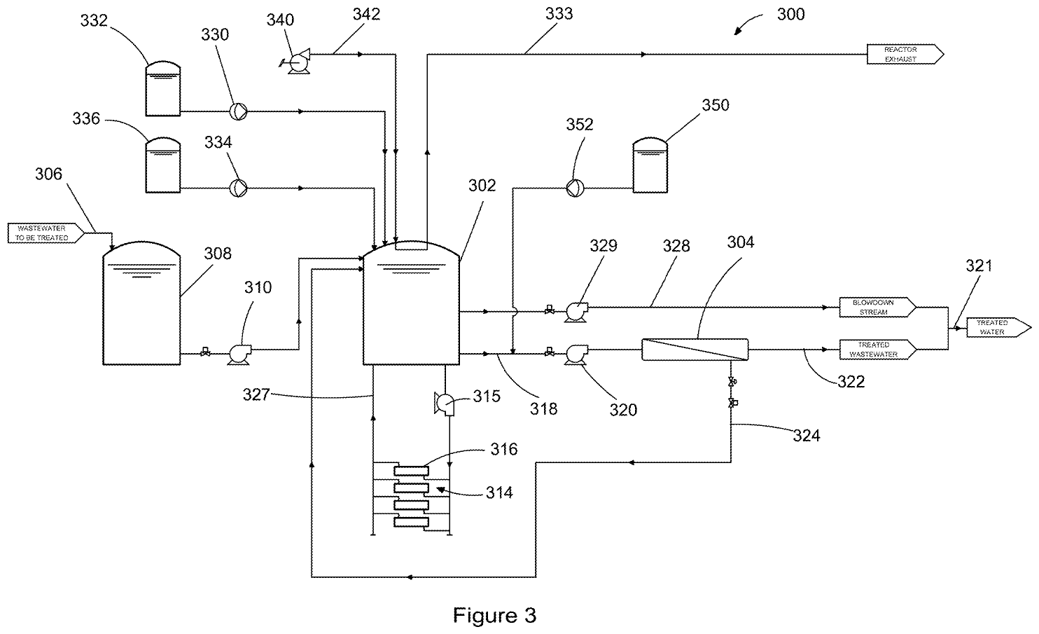

FIG. 3 illustrates another embodiment of the present invention. The electrochemical wastewater treatment system 300 comprises the same main components as the wastewater treatment systems illustrated in FIGS. 1 and 2, respectively a reactor tank 302, an electrochemical reactor 314 and a separation device 304, located downstream of the reactor tank 302. The stream of wastewater to be treated 306 is fed into an equalization tank 308 and through a pump 310 to the reactor tank 302. The wastewater from the reactor tank is supplied by pump 315 to the electrochemical reactor 314 which can comprise several electrochemical cells 316 where the wastewater is electrochemically treated. The reactor effluent stream 327 is fed back to the reactor tank 302.

An effluent wastewater stream 318 from the reactor tank 302 is fed by a pump 320 to the separation device 304 where soluble and insoluble compounds are filtered from the effluent wastewater stream 318 and the treated wastewater stream 322 flows out of the separation device 304. The membrane used in the separation device 304 can be a reverse osmosis membrane, a nano-filtration membrane, an ultrafiltration membrane or any other type of membrane which separates compounds via molecular size, charge, other characteristics, or via a combination of the above. The separation device 304 can use another separation process (e.g. distillation) instead of using a membrane for separating the soluble or insoluble contaminants from the effluent wastewater stream.

The reject stream 324 which is separated from the effluent wastewater stream 318 flows out of the separation device 304 and back to the reactor tank 302 to thereby increase the concentration of the contaminant and of the other soluble and insoluble compounds in the reactor tank 302 and further in the electrochemical reactor 314. In this embodiment, the entire reject stream 324 is returned to the reactor tank 302 as a recirculated wastewater stream consisting of concentrated wastewater. As in the embodiments described above, the soluble and insoluble compounds that are returned to the reactor tank 302 are selected according to the type of membrane or the type of process used in the separation device 304, and therefore the type and quantity of the contaminants and of all the soluble and insoluble compounds returned to the reactor tank 302 and which are carried over to the reactor 314 can be easily controlled.

As in the other embodiments, an air fan pump 340 pumps a stream of fresh air to the top of the reactor tank 302 to exhaust the gases generated during the wastewater treatment as reactor exhaust 333.

This embodiment is different from the first and the second embodiments described above in that the blowdown stream is not a portion of the reject stream. Instead, the blowdown stream 328 is discharged from the reactor tank 302 through a pump 329 and the contaminant concentration in the reactor tank 302 and further in the reactor 314 is controlled by controlling the volume of the reject stream 324 which is recirculated back to the reactor tank as a recirculated wastewater stream and by controlling the volume of the blowdown stream 328 which is discharged from the reactor tank 302.

Similar to the embodiment illustrated in Figurel, the blowdown stream 328 can be blended with the treated wastewater stream 322 to form a treated water stream 321, as illustrated in FIG. 3. The treated water stream can be discharged into a tank for reuse or storage, or can be discharged to a sewer or a surface water body.

As in the first embodiment, a solution for increasing the conductivity of the wastewater, for example sodium sulfate (Na₂SO₄) is supplied by a pump 330 from a tank 332 to the reactor tank 302 and a pH control solution, for example sodium hydroxide (NaOH) is supplied by a pump 334 from a tank 336. In the embodiments where the separation device uses a membrane for concentrating the contaminants, an antiscalant solution is fed by the pump 352 from the antiscalant solution tank 350 to the effluent wastewater stream and is carried over to the separation device 304 for maintaining the condition of the membrane.

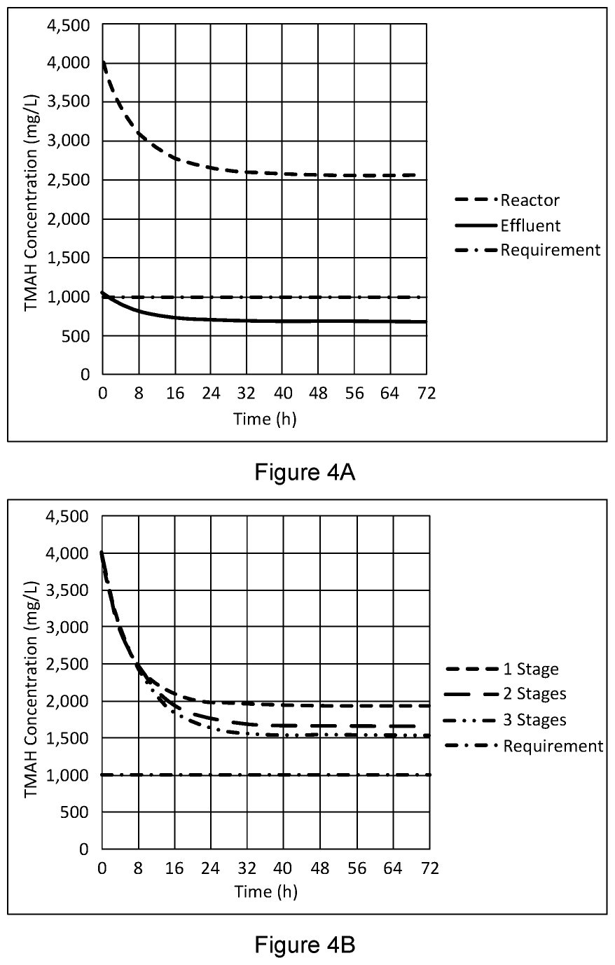

In the embodiments where the blowdown stream is implemented, the contaminant concentration in the reactor tank and implicitly in the electrochemical reactor can be better controlled. The modelling done using a system like the one illustrated in FIG. 1, having a tank reactor volume of 260 gallons and BDD (boron doped diamond) electrodes having a total active area of 15,000 cm² used to treat a wastewater stream containing 4,000 mg/L TMAH (tetramethyl ammonium hydroxide), at a current of 1,500 A with a current density of 0.1 A/cm², and controlling the volume of the reject stream to 75% of the effluent wastewater stream and the volume of the blowdown stream to 20% of the reject stream at fix flow rates of 0.18056 GMP, has shown that after 72 hours of operation the contaminant concentration in the treated water stream which is shown as effluent in FIG. 4A and which is the combination of the blowdown stream and of the treated wastewater stream dropped to 680 mg/L TMAH which represents a 83% reduction in contaminant concentration and is below the required contaminant concentration of 1,000 mg/L TMAH. This allows the system to operate at a higher average removal efficiency versus a batch reactor, and provide better effluent quality than a CSTR. These results are illustrated in FIG. 4A which represents the contamination concentration rate in the reactor, in the effluent (treated water stream) and the required contaminant concentration rate.

These results represent an improvement over the removal rate achieved under the same electrochemical active area by using a constantly stirred tank reactor with one, two or three stages, known by a person skilled in the art, where, after 72 h of operation, the contaminant concentration in the treated water stream stayed over the required contaminant concentration of 1,000 mg/L TMAH, as illustrated in FIG. 4B.

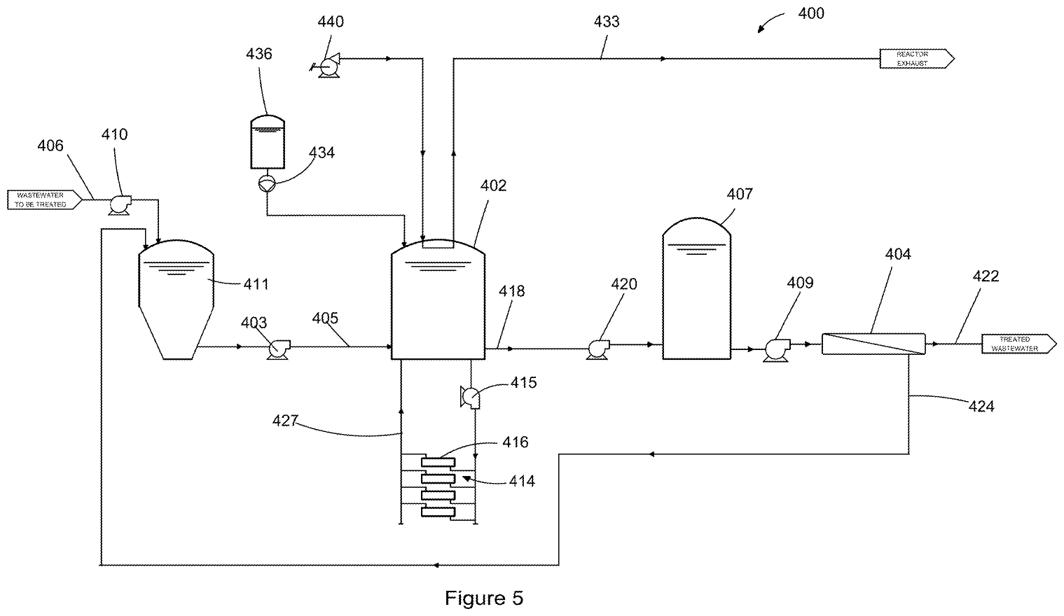

Another embodiment of the present system is illustrated in FIG. 5. In this embodiment, the electrochemical wastewater treatment system 400 comprises the same main components as the wastewater treatment systems illustrated in the previous embodiments, respectively a reactor tank 402, an electrochemical reactor 414 and a separation device 404, located downstream of the reactor tank 402. This embodiment is different than the previous embodiments because the stream of wastewater to be treated 406 is fed through a pump 410 to a conditioning tank 411 before it is supplied to the reactor tank 402. This is required because, in this embodiment, the system operates in batch mode, as further described below. Additionally, this allows to remove from the wastewater to be treated certain contaminants (e.g. metals) that could damage the membrane of the separation device 404. Consequently the wastewater from the stream 406 may be treated, for example by chemical precipitation, in the conditioning tank 411 to remove such contaminants. After treatment, the stream of pretreated wastewater 405 is fed by a pump 403 from the conditioning tank 411 to the reactor tank 402.

The wastewater is further supplied by pump 415 from the reactor tank 402 to the electrochemical reactor 414 which can comprise several electrochemical cells 416 where the wastewater is electrochemically treated. The reactor effluent stream 427 is fed back to the reactor tank 402.

An effluent wastewater stream 418 coming out from the reactor tank 402 is fed by a pump 420 to a membrane feed tank 407 and further by a pump 409 to a separation device 404, where soluble and insoluble compounds are filtered from the effluent wastewater stream 418 and the treated wastewater stream 422 flows out of the separation device 404. As in the other embodiments, the membrane used in the separation device 404 can be a reverse osmosis membrane, a nano-filtration membrane, an ultrafiltration membrane or any other type of membrane which separates compounds via molecular size, charge, other characteristics, or via a combination of the above.

The reject stream 424 which is separated from the effluent wastewater stream 418 flows out of the separation device 404 and back to the conditioning tank 411 as a recirculated water stream to thereby increase the concentration of the contaminant(s) and of the other soluble and insoluble compounds in the incoming wastewater and further in the reactor tank 402 and in the electrochemical reactor 414. In this embodiment, the entire reject stream 424 is returned to the conditioning tank 411 as a recirculated wastewater stream, and it is then supplied to the reactor tank and to the electrochemical reactor. Such embodiments, where there is no blowdown stream and the entire reject stream is returned to the reactor tank is advantageous for those applications where the wastewater to be treated contains organics with strict discharge limits for example and it is beneficial for the system to feed the entire amount of such components back into the system. The same applies for the conductivity enhancing substances which are entirely recycled within the system. In such embodiments, the amount of contaminants which is fed back to the reactor tank and to the reactor is controlled by type and the characteristics of the separation device 404.

The schematic illustrates symbolically a chemical delivery system 436 which delivers, through a pump 434, the required addition chemicals to the reactor tank 402. Such chemicals can include a solution for increasing the conductivity of the wastewater, for example sodium sulfate (Na₂SO₄), a pH control solution, for example sodium hydroxide (NaOH) and/or an antiscalant or biocide solution for maintaining the condition of the membrane of the separation device 404, if a membrane is used.

As in the embodiments described above, the soluble and insoluble compounds that are returned to the reactor tank 402 are selected according to the type of the separation device 404 (e.g. the type of membrane used), and therefore the type and quantity of the contaminants and of all the soluble and insoluble compounds returned to the reactor tank 402 and which are carried over to the reactor 414 can be easily controlled.

As in the other embodiments, an air fan pump 440 pumps a stream of fresh air to the top of the reactor tank 402 to exhaust the gases generated during the wastewater treatment as reactor exhaust 433.

The system illustrated in FIG. 5 operates in batch mode, which means that a certain quantity of wastewater (a batch) is supplied to the conditioning tank 411 and further to the reactor tank 402 and it is further treated in the reactor 414 and recirculated through the system for a preset amount of time which is long enough for a required contaminant removal, and the next batch of wastewater to be treated is fed to the conditioning tank and to the reactor tank only after the first batch of wastewater was completely treated and discharged from the system. The effluent wastewater stream 418 can be continuously supplied to the separation device 404 and the reject stream 424 can be continuously fed back into the system similar to the recirculated wastewater stream in the embodiments illustrated in FIGS. 1 and 2, to control the amount of contaminants. The system operates in a series of distinct process steps wherein the tanks are filled and drained in a specific set order that repeats over time.

The advantage of the present system and method is that the concentration of soluble and insoluble compounds in the reactor is decoupled from the concentration of the compounds in the reactor effluent stream and this achieves an improved reactor performance and a higher quality effluent.

In the present invention the term “soluble and insoluble compounds” is also meant to include various contaminants found in the wastewater which need to be removed through the electrochemical treatment of the wastewater.

Even if a blowdown stream is illustrated in all the figures presented here, a person skilled in the art would understand, based on the teachings of the present disclosure, that a blowdown stream is not required in all cases for controlling the concentration of the compounds in the reactor tank and in the reactor.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. Such modifications are to be considered within the purview and scope of the claims appended hereto.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, if any, including U.S. Provisional Patent Application No. 62/750,354, filed Oct. 25, 2018, are incorporated herein by reference, in their entirety. Aspects of the embodiments can be modified, if necessary to employ concepts of the various patents, applications and publications to provide yet further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An electrochemical wastewater treatment system comprising:
a reactor tank which receives a stream of wastewater to be treated;
an electrochemical reactor; and
a separation device which receives an effluent wastewater stream from the reactor tank to generate a treated wastewater stream which is discharged from the system and a reject stream, which is at least partially supplied to the electrochemical reactor or back to the reactor tank as a recirculated wastewater stream,
wherein the electrochemical reactor treats the recirculated wastewater stream supplied from the separation device or the wastewater supplied from the reactor tank which contains the recirculated wastewater stream and generates a reactor effluent stream which is fed back to the reactor tank.

2. The wastewater treatment system of claim 1 further comprising
control means for adjusting the volume of the reject stream and of the recirculated wastewater stream for controlling the concentration of compounds in the electrochemical reactor.

3. The wastewater treatment system of claim 1 further comprising a blowdown stream, which discharges from the system a portion of the reject stream, and control means for adjusting the volume of the blowdown stream.

4. The wastewater treatment system of claim 1 further comprising a blowdown stream which discharges from the system a portion of the wastewater contained in the reactor tank and control means for adjusting the volume of the blowdown stream.

5. The wastewater treatment system of claim 3 or 4 wherein the blowdown stream and the treated wastewater stream are combined into a treated water stream before being discharged from the system.

6. The wastewater treatment system of claim 2 wherein the control means for adjusting the volume of the reject stream and/or of the recirculated wastewater stream comprise a pump for feeding the effluent wastewater stream from the reactor tank to the separation device and/or a valve which regulates the flow of the reject stream and/or at least a valve which regulates the flow of the recirculated wastewater stream.

7. The wastewater treatment system of claim 3 or 4 wherein the control means for adjusting the volume of the blowdown stream comprise at least one valve for regulating the flow of the blowdown stream.

8. The wastewater treatment system of claim 1 wherein the separation device comprises a reverse osmosis membrane, a nanofiltration membrane, or an ultrafiltration membrane, or uses another separation process for filtrating the compounds in the wastewater.

9. The wastewater treatment system of claim 8 wherein the type and the characteristics of the separation device are selected for controlling the concentration of the compounds in the reject stream.

10. The wastewater treatment system of claim 1 further comprising a device for storing and delivering to the reactor tank a solution for increasing the wastewater conductivity, a solution for controlling the pH of the wastewater and/or a membrane descaling solution.

11. The wastewater treatment system of claim 1 further comprising a conditioning tank which receives a predetermined amount of the stream of wastewater to be treated before it is supplied to the reactor tank and the recirculated wastewater stream supplied from the separation device, wherein in the conditioning tank the wastewater to be treated is mixed with the recirculated wastewater stream and it is treated to remove specific compounds.

12. The wastewater treatment system of claim 11 further comprising a membrane feed tank which receives the effluent wastewater stream from the reactor tank and a pump which supplies the wastewater from the membrane feed tank to the separation device.

13. A method for wastewater treatment in an electrochemical reactor comprising the steps of:
a. supplying the wastewater to be treated to a reactor tank and discharging an effluent wastewater stream from the reactor tank;
b. supplying the effluent wastewater stream from the reactor tank to a separation device where the effluent wastewater stream is concentrated to generate a treated wastewater stream and a reject stream which contains the compounds which were rejected by the separation device;
c. supplying at least a portion of the reject stream to an electrochemical reactor or back to the reactor tank as a recirculated wastewater stream;
d. electrochemically treating the recirculated wastewater stream or the wastewater supplied from the reactor tank, which contains the recirculated wastewater stream, in the electrochemical reactor and generating a reactor effluent stream of electrochemically treated water;
e. supplying the reactor effluent stream from the electrochemical reactor to the reactor tank;
f. controlling the volume of the reject stream and/or of the recirculated wastewater stream supplied either to the electrochemical reactor or to the reactor tank for controlling the concentration of the compounds in the electrochemical reactor, and
g. discharging the treated wastewater stream from the system.

14. The method of claim 13 further comprising discharging a portion of the reject stream as a blowdown stream to further control the compounds concentration in the electrochemical reactor.

15. The method of claim 13 further comprising discharging a portion of the wastewater contained in the reactor tank as a blowdown stream to further control the compounds concentration in the electrochemical reactor.

16. The method of claim 14 or 15 wherein the blowdown stream is combined with the treated wastewater stream before being discharged from the system.

17. A method for wastewater treatment in an electrochemical reactor comprising the steps of:
a. supplying a predetermined volume of wastewater to be treated to a conditioning tank and from the conditioning tank to a reactor tank and discharging an effluent wastewater stream from the reactor tank;
b. supplying the effluent wastewater stream from the reactor tank to a membrane feed tank and from the membrane feed tank to a separation device where the effluent of wastewater stream is concentrated to generate a treated wastewater stream and a reject stream which contains the compounds which were rejected by the separation device;
c. supplying the entire reject stream to the conditioning tank where it is mixed with the wastewater to be treated and it is further supplied to the reactor tank;
d. supplying the wastewater from the reactor tank which comprises the reject stream to an electrochemical reactor;
e. electrochemically treating the wastewater supplied from the reactor tank in the electrochemical reactor and generating a reactor effluent stream;
f. supplying the reactor effluent stream from the electrochemical reactor back to the reactor tank;
g. discharging the treated wastewater stream from the system; and
h. supplying a new volume of wastewater to be treated to the conditioning tank and repeating the steps above.

18. The method of claim 17 wherein the type and the characteristics of the separation device are selected for controlling the concentration of the compounds in the reject stream.

19. The method of claim 17 further comprising storing and delivering to the reactor tank a solution for increasing the wastewater conductivity, a solution for controlling the pH of the wastewater and/or a membrane descaling solution.
